(19) United States
(12) Patent Application Publication
(10) Pub. No.: US 2019/0356464 A1
(43) Pub. Date: Nov. 21, 2019

(54) Methods and Systems for Communication Using Dual Connectivity Wireless Transceiver

(71) Applicant: Phazr, Inc., Allen, TX (US)

(72) Inventors: Farooq Khan, Allen, TX (US); Khurram Muhammad, Fort Worth, TX (US); Rakesh Taori, McKinney, TX (US); Sudhir Ramakrishna, Plano, TX (US); Eran Pisek, Plano, TX (US); Shadi Abu-Surra, Plano, TX (US)

(21) Appl. No.: 15/985,630

(22) Filed: May 21, 2018

(51) Int. Cl. H04L 5/14; H04W 72/04; H04L 5/00

(52) U.S. Cl. CPC H04L 5/14; H04B 7/0617; H04L 5/0048; H04W 72/0453

(57) ABSTRACT

A method for wireless communication includes generating first and second digital baseband signal streams. The method further includes digitally up-converting the first digital baseband signal streams to a first digital intermediate frequency (IF) signal of frequency f1 and digitally up-converting the second digital baseband signal streams to a second digital intermediate frequency (IF) signal of frequency f2, wherein f1 is not equal to f2. The method also includes converting the first digital IF signal of frequency f1 to a first analog IF signal of frequency f1 and converting the second digital IF signal of frequency f1 to a second analog IF signal of frequency f2. The method also includes up-converting the first analog IF signal to a millimeter wave band signal. The method also includes transmitting the millimeter wave band signal and the second analog IF signal.

### BACKGROUND

The invention relates to wireless communications, and in particular relates to methods and systems for wireless communications using dual-connectivity transceivers.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems, whereas the 4G LTE systems provide wide area long-range connectivity both outdoors and indoors using dedicated infrastructure such as cell towers and backhaul to connect to the Internet.

As more people connect to the Internet, increasingly chat with friends and family, watch and upload videos, listen to streamed music, and indulge in virtual or augmented reality, data traffic continues to grow exponentially. In order to address the continuously growing wireless capacity challenge, the next generation of LAN and WAN systems are relying on higher frequencies referred to as millimeter waves in addition to currently used frequency bands below 7 GHz. The next generation of wireless WAN standard referred to as 5G New Radio (NR) is under development in the Third Generation Partnership Project (3GPP). The 3GPP NR standard supports both sub-7 GHz frequencies as well as millimeter wave bands above 24 GHz. In 3GPP standard, frequency range 1 (FR1) covers frequencies in the 0.4 GHz-6 GHz range. Frequency range 2 (FR2) covers frequencies in the 24.25 GHz-52.6 GHz range. Table 1 provides examples of millimeter wave bands including FR2 bands that may be used for wireless high data-rate communications. Table 2 separately lists examples of FR2 bands in the 3GPP standard. In the millimeter wave bands above 24 GHz, a time division duplexing (TDD) scheme is generally preferred. However, regulations in most parts of the World allow using other duplexing schemes including frequency division duplexing (FDD).

TABLE 1
Examples of millimeter wave bands

| | | | Bandwidth |
|---|---|---|---|
| Bands [GHz] | | Frequency [GHz] | [GHz] |
| 26 | GHz Band | 24.25-27.5 | 3.250 |
| LMDS Band | | 27.5-28.35 | 0.850 |
| | | 29.1-29.25 | 0.150 |
| | | 31-31.3 | 0.300 |
| 32 | GHz Band | 31.8-33.4 | 1.600 |
| 39 | GHz Band | 38.6-40 | 1.400 |
| 37/42 | GHz Bands | 37.0-38.6 | 1.600 |
| | | 42.0-42.5 | 0.500 |
| 47 | GHz | 47.2-48.2 | 1.000 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| 150/160 | GHz | 151.5-155.5 | 12.50 |
| | | 155.5-158.5 | |
| | | 158.5-164 | |

TABLE 2
Examples of FR2 bands in 3GPP

| 5G-NR | | |
|---|---|---|
| Frequency | Uplink (UL) and Downlink (DL) | Duplex |
| Band | operating band | Mode |
| n257 | 26500 MHz-29500 MHz | TDD |
| n258 | 24250 MHz-27500 MHz | TDD |
| n260 | 37000 MHz-40000 MHz | TDD |

Table 3 lists examples of FR1 bands in the 3GPP standard. We refer to the FR1 bands in the 3GPP standard, unlicensed 2.4 GHz and 5 GHz bands, 5.925-6.425 GHz and 6.425-7.125 GHz bands and any other spectrum band below 7 GHz as sub-7 GHz spectrum. The duplexing schemes used in the sub-7 GHz spectrum, among others, can be time division duplexing (TDD), frequency division duplexing (FDD), supplemental downlink (SDL) or supplemental uplink (SUL).

TABLE 3
Examples of FR1 bands in 3GPP

| 5G-NR | | | |
|---|---|---|---|
| Frequency | Uplink | Downlink | Duplex |
| Band | Frequency band | Frequency band | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n38 | 2570 MHz-2620 MHz | 2570 MHz-2620 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

In addition to serving mobile devices, the next generation of wireless WAN systems using millimeter wave and sub-7 GHz spectrum are expected to provide high-speed (Gigabits per second) links to fixed wireless broadband routers installed in homes and commercial buildings.

### SUMMARY

Various aspects of the present disclosure are directed to methods and systems for wireless communications using dual-connectivity transceivers. In one aspect of the present disclosure, a method for wireless communication includes generating first and second digital baseband signal streams. The method further includes digitally up-converting the first digital baseband signal streams to a first digital intermediate frequency (IF) signal of frequency f1 and digitally up-converting the second digital baseband signal streams to a second digital intermediate frequency (IF) signal of frequency f2, wherein f1 is not equal to f2. The method also includes converting the first digital IF signal of frequency f1 to a first analog IF signal of frequency f1 and converting the second digital IF signal of frequency f1 to a second analog IF signal of frequency f2. The method also includes up-converting the first analog IF signal of frequency f1 to a millimeter wave band signal of frequency f3. The method also includes amplifying the millimeter wave band signal of frequency f3 and transmitting the amplified millimeter wave band signal of frequency f3. The method also includes amplifying the second analog signal of frequency f2 and transmitting the amplified signal, wherein f3 is greater than f2 by at least 10 GHz.

In an additional aspect of the disclosure, a method for wireless communication includes receiving millimeter wave band signals of frequency f3 and sub-7 GHz signals of frequency f2. The method further includes amplifying the millimeter wave band signals of frequency f3 and the sub-7 GHz signals of frequency f2. The method also includes down-converting the amplified millimeter wave band signals of frequency f3 to first analog intermediate frequency (IF) signals of frequency f1. The method also includes converting the first analog IF signals of frequency f1 to first digital IF signals of frequency f1 and converting the amplified sub-7 GHz signals to second digital IF signals. The method also includes digitally down-converting the first and second digital IF signals to respective first and second digital baseband signals.

In an additional aspect of the disclosure, an apparatus configured for wireless communication includes means for generating first and second digital baseband signal streams. The apparatus further includes means for digitally up-converting the first digital baseband signal streams to a first digital intermediate frequency (IF) signal of frequency f1. The apparatus also includes means for digitally up-converting the second digital baseband signal streams to a second digital intermediate frequency (IF) signal of frequency f2, wherein f1 is not equal to f2. The apparatus also includes means for converting the first digital IF signal of frequency f1 to a first analog IF signal of frequency f1. The apparatus also includes means for converting the second digital IF signal of frequency f1 to a second analog IF signal of frequency f2. The apparatus also includes means for up-converting the first analog IF signal of frequency f1 to a millimeter wave band signal of frequency f3. The apparatus also includes means for amplifying the millimeter wave band of frequency f3 and transmitting the amplified millimeter wave band signal of frequency f3. The apparatus also includes means for amplifying the second analog signal of frequency f2 and transmitting the amplified signal, wherein f3 is greater than f2 by at least 10 GHz.

In an additional aspect of the disclosure, an apparatus configured for wireless communication includes means for receiving millimeter wave band signals of frequency f3 and sub-7 GHz signals of frequency f2 and means for amplifying the millimeter wave band signals of frequency f3 and the sub-7 GHz signals of frequency f2. The apparatus further includes means for down-converting the amplified millimeter wave band signals of frequency f3 to first analog intermediate frequency (IF) signals of frequency f1. The apparatus also includes means for converting the first analog IF signals of frequency f1 to first digital IF signals of frequency f1 and means for converting the amplified sub-7 GHz signals to second digital IF signals. The apparatus also includes means for digitally down-converting the first and second digital IF signals to respective first and second digital baseband signals.

In an additional aspect of the disclosure, a method for wireless communication includes generating N digital baseband signal streams and digitally up-converting the digital baseband signal streams to at least two digital intermediate frequency (IF) signals of frequency f1 and frequency f2. The method also includes converting the digital IF signals of frequency f1 and frequency f2 to an analog IF signal having frequencies f1 and f2. The method also includes filtering the analog IF signal having frequencies f1 and f2 to generate a first analog IF signal of frequency f1. The method also includes filtering the analog IF signal having frequencies f1 and f2 to generate a second analog IF signal of frequency f2. The method also includes up-converting the first analog IF signal of frequency f1 to a millimeter wave band signal of frequency f3. The method also includes amplifying the millimeter wave band of frequency f3 and transmitting the amplified millimeter wave band signal of frequency f3. The method also includes amplifying the second analog signal of frequency f2 and transmitting the amplified signal, wherein f3 is greater than f2 by at least 10 GHz.

### BRIEF DESCRIPTION OF THE DRAWINGS

FIG. 1 illustrates a wireless communication system according to an embodiment of the present disclosure.

FIG. 2 illustrates physical channels and physical signals.

FIG. 3 illustrates transmit MIMO and beamforming chain and receive MIMO and beamforming chain.

FIG. 4 illustrates a base station according to an embodiment of the present disclosure.

FIGS. 5-7 illustrate dual connectivity wireless transceivers according to embodiments of the present disclosure.

FIGS. 8-9 are functional block diagrams illustrating example blocks executed to implement aspects of the present disclosure.

### DETAILED DESCRIPTION

The techniques described herein may be used for various wireless communication networks such as wireless LAN, fourth Generation (4G) LTE cellular mobile, Fifth Generation (5G) cellular mobile and other networks such as, for example, fixed wireless access (FWA) networks. The terms “network” and “system” are often used interchangeably.

Embodiments of the present disclosure which will be described below provide methods and systems for dual connectivity across Millimeter wave and sub-7 GHz bands.

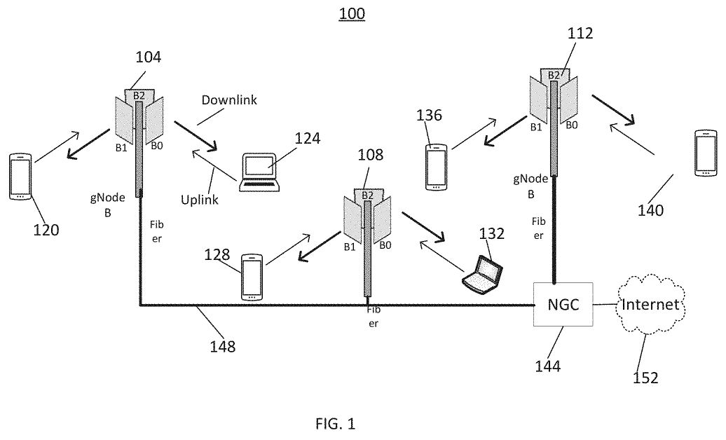

FIG. 1 illustrates a wireless communication system 100 according to an embodiment of the present disclosure. The wireless communication system 100 uses both millimeter wave spectrum above 24 GHz and sub-7 GHz spectrum. The wireless communication system 100 may use millimeter wave spectrum above 24 GHz for both uplink or downlink, sub-7 GHz spectrum for both uplink or downlink or millimeter wave spectrum above 24 GHz for downlink and sub-7 GHz spectrum for uplink.

Referring to FIG. 1, the wireless system 100 includes radio base stations 104, 108 and 112 (also referred to as gNode Bs) that communicate with communication devices 120, 124, 128, 132, 136 and 140. By way of example, radio base stations 104, 108 and 112 can provide 360 degrees coverage by using three sectors each sector covering 120 degrees. Each sector may be further divided into P sub-sectors with each sub-sector covering 120/P degrees. For example, for the case when a sector is further divided into three sub-sectors, each sector provides 40 degrees coverage. The radio base stations gNode Bs 104, 108 and 112 are connected to a network 144 (e.g., Next Generation Core (NGC) network) using a communication link 148 (e.g., high-speed Fiber backhaul link). The network 144 may be connected to the Internet 152. The radio base station 104 serves communication devices 120 and 124, the radio base station 108 serves communication devices 128 and 132, and the radio base station 112 serves communication devices 136 and 140. The communication devices may, for example, be smartphones, laptop computers, desktop computers, augmented reality/virtual reality (AR/VR) devices or any other communication devices.

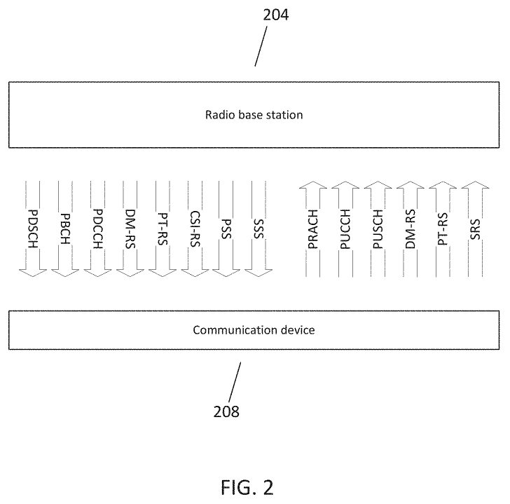

FIG. 2 illustrates uplink physical channels and uplink physical signals transmission and reception, and downlink physical channels and downlink physical signals transmission and reception according to an embodiment of the present disclosure. By way of example, a radio base station 204 communicates with a communication device 208 on the downlink and on the uplink. An uplink physical channel corresponds to a set of resource elements carrying information originating from higher layers. The uplink physical channels transmitted from a communication device 208 and received by the radio base station 204 include: Physical Uplink Shared Channel (PUSCH), Physical Uplink Control Channel (PUCCH), Physical Random Access Channel (PRACH). An uplink physical signal is used by the physical layer but does not carry information originating from higher layers. The uplink physical signals transmitted from the communication device 208 and received by the radio base station 204 include: Demodulation reference signals (DM-RS), Phase-tracking reference signals (PT-RS) and Sounding reference signal (SRS).

A downlink physical channel corresponds to a set of resource elements carrying information originating from higher layers. The downlink physical channels transmitted from the radio base station 204 and received by the communication device 208 include: Physical Downlink Shared Channel (PDSCH), Physical Broadcast Channel (PBCH) and Physical Downlink Control Channel (PDCCH). A downlink physical signal corresponds to a set of resource elements used by the physical layer but does not carry information originating from higher layers. The downlink physical signals transmitted from the radio base station 204 and received by the communication device 208 include: Demodulation reference signals (DM-RS), Phase-tracking reference signals (PT-RS) Channel-state information reference signal (CSI-RS) Primary synchronization signal (PSS) and Secondary synchronization signal (SSS).

Referring to FIG. 2, the downlink physical channels and downlink physical signals and uplink physical channels and uplink physical signals can be transmitted in the millimeter wave spectrum such as 26, 28, 37 and 39 GHz bands or the sub-7 GHz spectrum such as 3.5-4.2 GHz licensed or 5 GHz unlicensed bands or simultaneously on both the Millimeter wave bands and the sub-7 GHz spectrum bands. In other embodiments, the downlink physical channels and downlink physical signals are carried in the millimeter wave spectrum such as 26, 28, 37 and 39 GHz bands while the uplink physical channels and uplink physical signals are carried in the sub-7 GHz spectrum such as 3.5-4.2 GHz licensed or 5 GHz unlicensed bands.

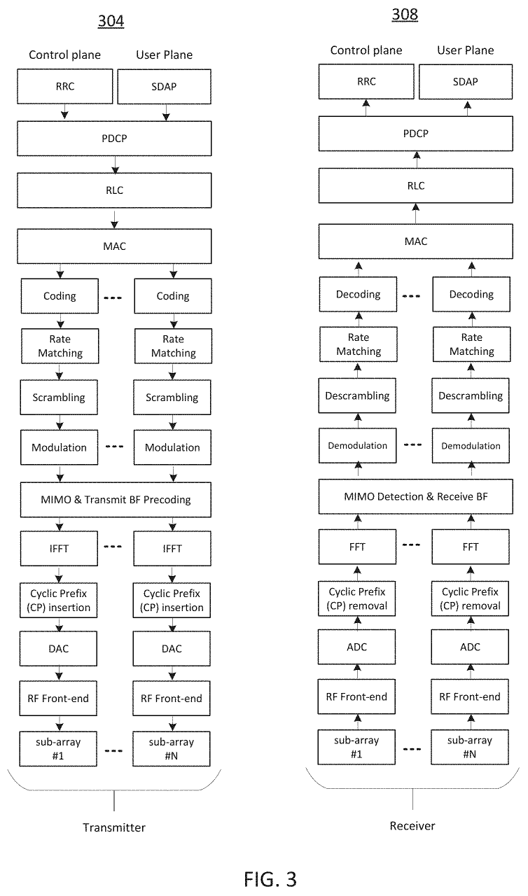

FIG. 3 illustrates transmit MIMO and beamforming chain 304 and receive MIMO and beamforming chain 308 according to some disclosed embodiments.

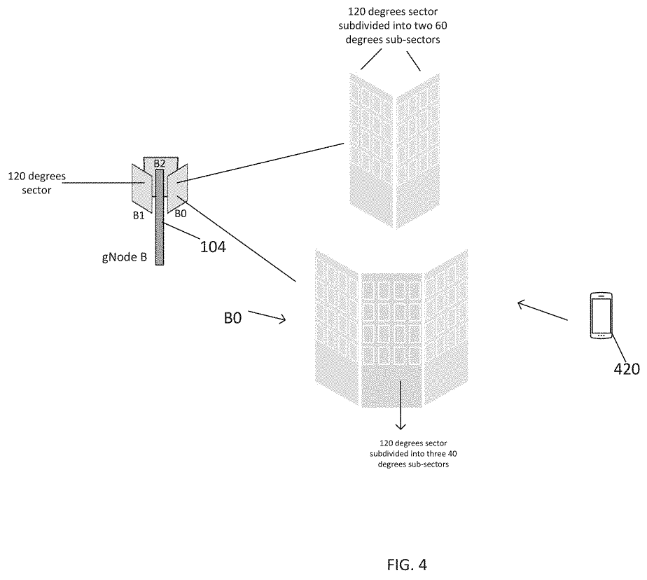

FIG. 4 illustrates the base station 104 according to an embodiment of the present disclosure. The base station 104 may include a plurality of sectors, each providing coverage for a zone or sector. By way of example, the base station 104 has three sectors B0, B1 and B2. Each sector provides coverage in the 120 degrees zone with 3-sectors providing 360 degrees coverage. Each sector may include a plurality of sub-sectors. For example, to provide coverage in the 120 degrees zone, a sector may consist of 2 sub-sectors with each sub-sector providing coverage in the 60 degrees zone or 3 sub-sectors with each sub-sector providing coverage in the 40 degrees zone. Although the exemplary base stations are shown to have three sectors, it will be understood that the base stations may include only one sector or any suitable number of sectors. Each sub-sector may include a plurality of antenna sub-arrays.

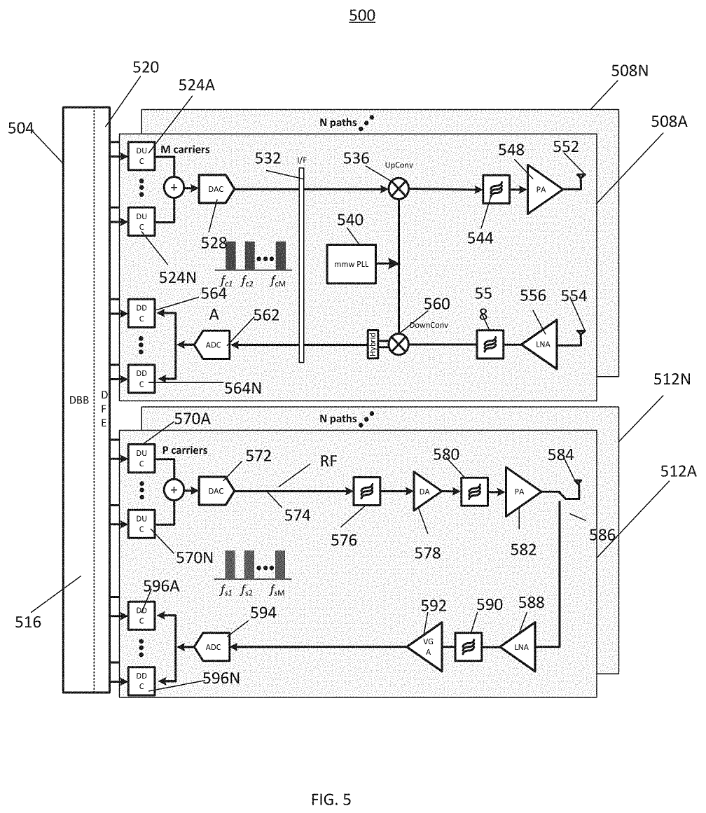

FIG. 5 illustrates a dual connectivity wireless transceiver 500 according to an embodiment of the present disclosure. The dual connectivity wireless transceiver 500 may be utilized as transceivers in the base station 104. Also, the dual connectivity wireless transceiver 500 may be utilized as transceivers in user equipment such as, for example, a wireless broadband modem, a mobile phone, a smart phone, a lap top computer or any other communication device. The dual connectivity transceiver 500 is configured for MIMO communications with N transmit and N receive paths.

In one aspect of the present disclosure, the transceiver 500 comprises a single baseband module 504 connected to millimeter wave modules 508A-508N and also to sub-7 GHz modules 512A-512N. Each millimeter wave module provides a single transmit path and a single receive path. Thus, a total of N millimeter wave transmit paths and N millimeter wave receive paths are provided by the millimeter wave modules 508A-508N. Likewise, the sub-7 GHz modules 512A-512N provide a total of N sub-7 GHz transmit paths and N sub-7 GHz receive paths. Thus, the transceiver 500 utilizes a single baseband module 504 connected to the millimeter wave modules 508A-508N and the sub-7 GHz modules 512A-512N to provide wireless communication in the millimeter wave band and in the sub-7 GHz band. In other embodiments, the total number transmit paths and the total number of receive paths can be different. Also, the number of millimeter wave transmit and receive paths can be different from sub-7 GHz band transmit and receive paths.

According to an embodiment of the present disclosure, the baseband module 504 includes a digital baseband (DBB) module 516 and a digital front-end (DFE) 520. The digital baseband module 516 implements digital functions such as channel coding, modulation, MIMO/beamforming, and OFDMA (Orthogonal Frequency Division Multiple Access) processing. The digital baseband module 516 generates N transmit waveforms for each carrier frequency (f_{c1}, f_{c2}, . . . , f_{cM}), and receives N receive waveforms for each carrier frequency (f_{c1}, f_{c2}, . . . , f_{cM}) in N transmit and receive paths. The digital front-end 520 compensates for analog imperfections in the transmit and receive paths. Also, the digital front-end 520 performs other functions such as crest factor reduction (CFR) and digital predistortion (DPD) in transmit paths.

In each of the millimeter wave modules (e.g., 508A), for each transmit path, the transmit waveforms for each carrier frequency (f_{c1}, f_{c2}, . . . , f_{cM}) are digitally upconverted by digital upconverters 524A-524N to create the appropriate offset between the carriers. The outputs of the digital upconverters are summed and converted from digital to analog signals by a digital to analog converter (DAC) 528. The aggregated analog waveform carrying the M carriers, which is also referred to herein as I/F transmit signal, is up-converted by upconverter 536 that translates the frequency f_{c1} to a desired millimeter wave (mmw) frequency. The upconverter 536 may also implement driver amplifier and image-rejection capabilities eliminating need for additional filtering. The upconverter 536 mixes the aggregated waveform with the output of a phase locked loop (PLL) 540, which creates sum and difference frequencies in addition to several undesired intermodulation products. The upconverted waveform is passed through a bandpass filter such as an RF filter 544 to extract the desired frequency band which is amplified by a power amplifier 548 and transmitted by an antenna 552. This sequence of operations is repeated in each transmit path of the millimeter wave modules 508A-508N.

Referring to the millimeter wave module 508A, in the receive direction signals received by an antenna 554 are amplified by a low noise antenna (LNA) 556. The millimeter wave antenna may consist of sub-antennas such as an antenna array. A mmw filter 558 coupled to the output of the LNA 556 suppresses any interferer or noise in the image frequency band. The filtered signal is then down-converted by a down-converter 560 to an intermediate frequency IF and passed through to an analog to digital converter (ADC) 562 which converts this signal to digital signals which comprises carriers (f_{c1}, f_{c2}, . . . , f_{cM}).

Next digital down-converters 564A-564N down-converts the carriers (f_{c1}, f_{c2}, . . . , f_{cM}) (i.e., mixes down digitally) and passes on to the digital front end 520 where compensations are applied for analog impairments before time domain to frequency domain conversion and MIMO detection by the digital baseband module 516. Image is rejected in the down-conversion by I/Q down-conversion and any residual image can be reduced using IQ mismatch reduction techniques. In some embodiments, the number of transmit and receive paths in the millimeter wave modules may be different.

Referring to the sub-7 GHz modules 512A-512N, for each transmit path, the transmit waveforms for each carrier frequency (fₛ₁, fₛ₂, . . . , f_{sM}) are digitally upconverted by digital upconverters 570A-570N to create the appropriate offset between the carriers. The outputs of the digital upconverters are summed and converted from digital to analog signals by a digital to analog converter (DAC) 572. In other embodiments, the DAC 572 may implement direct RF sampling eliminating the need for separate up-conversion as up-conversion is done as part of the direct RF sampling.

According to an embodiment of the present disclosure, the synthesized transmit waveform for sub-7 GHz band is filtered by filter 576 and amplified through an optional sub-7 GHz driver amplifier (DA) 578. The output of the DA 578 is filtered again by a filter 580 to suppress adjacent channel leakage and out-of-band (00B) spurs and amplified by a power amplifier (PA) 582. The amplified waveforms are radiated in the air through an antenna 584. In some embodiments, the number of transmit paths in the sub-7 GHz modules may be different than the number of transmit paths in the millimeter wave modules. In some embodiments, the number of transmit and receive paths in the sub-7 GHz modules may be different.

According to an embodiment of the present disclosure, the sub-7 GHz modules 512A-512N use time division duplexing (TDD) and a transmit-receive (TR) switch 586 to connect the PA 582 to the antenna 584 during transmission and to disconnect a low noise amplifier (LNA) 588 from the antenna 564. Thus, when the sub-7 GHz modules are in a transmit mode, the TR switch 586 disconnects the receive path from the antenna 584.

When the sub-7 GHz modules are in a receive mode, the TR switch 586 connects the LNA 588 to the antenna 584 but disconnects the PA 582 from the antenna 584. Received signal from the antenna 584 is amplified by the LNA 588 and filtered by a filter 590. A variable gain amplifier (VGA) 592 further amplifies the signal which is then converted to digital signals by an analog to digital converter (ADC) 594. Next digital down-converters 596A-596N down-convert the carriers (fₛ₁, fₛ₂, . . . , f_{sM}) (i.e., mixes down digitally) and passes on to the digital front end 520 where compensations are applied for the analog impairments before time domain to frequency domain conversion and MIMO detection by the digital baseband module 516.

According to an embodiment of the present disclosure, intermediate frequencies are selected independently for the millimeter wave modules 508A-508N and the sub-7 GHz modules 512A-512N. Thus, in the transmit direction the output signals of the DAC 528 (in millimeter wave modules 508A-508N) may have different frequencies than the output signals of the DAC 572 (in millimeter wave modules 512A-512N).

In the sub-7 GHz modules, if the DAC 572 or ADC 594 cannot sample the sub7-GHz band directly, an additional stage is required between the data converters (DAC 572 and ADC 594) and the RF elements that would translate the sub-7 GHz frequency to a desired IF frequency by mixing up or down and using a second phase locked loop (not shown in FIG. 5). This desired IF frequency would be the one that falls within the specification of the data converters.

According to an embodiment of the present disclosure, the IF frequency used for the millimeter wave paths (e.g., output of DAC 528) in the millimeter wave modules 508A-508N is different from the IF frequency used by the sub-7 GHz paths (e.g., output of DAC 572) in the sub-7 GHz modules 512A-512N in order to reduce any interaction between the two paths due to radio frequency (RF) leakage. If the same IF frequency is used for both paths, then it is necessary to isolate the two paths sufficiently such that leakage from transmit path of one channel does not impact the reception in the other channel.

The dual connectivity wireless transceiver 500 illustrated in FIG. 5 can implement either a time division duplex (TDD) or a frequency division multiplexed (FDD) system for either the millimeter wave modules 508A-508N or the sub-7 GHz modules 512A-512N or can implement any combination thereof. In some embodiments supporting TDD operation such as, for example, the sub-7 GHz modules 512A-512N illustrated in FIG. 5, the transmit/receive paths may be connected to the same antenna 584 via a TDD switch controlled by a transmit-receive (T/R) signal from the digital baseband module 504. In contrast, the transmit and receive paths in the millimeter wave modules 508A-508N have their own independent antennas that allow this system to be operated either as TDD or FDD system.

In some embodiments of the present disclosure, the sub-7 GHz modules 512A-512N may also be configured with independent antennas for the transmit and receive paths, and in that case the T/R switch is eliminated however, the PA must be muted when the modules are in a receive mode if implementing a TDD operation. Therefore, T/R signal is still needed to be controlled by the DBB 516 despite its role being reduced to PA muting only. In FDD operation, this T/R signal is no longer needed, however, sufficient isolation must be present such that the leakage from the PA is low enough at the input of the LNA such as to cause insignificant degradation to sensitivity of the receiver.

According to an embodiment of the present disclosure, the millimeter wave modules 508A-508N are operated in TDD mode. Therefore, the PA 548 is muted in the receive mode. This function may be implemented by a control signal from the DBB 516. The PA 548 is ramped up and down using a controlled waveform such as to not spill energy that exceeds the limits outside the allowed frequency band of operation imposed by communications regulatory authority of the country where such system is in use. The same type of control is also required in the sub-7 GHz modules where the T/Rs control signal timing may be completely independent of the same control signal used in the millimeter wave modules. This is because the sub-7 GHz modules and the millimeter wave modules may be operated using different system numerologies and frame structures, leading to different transmission and reception times for these sections Therefore, the baseband must correctly determine the timing advance necessary for the millimeter wave communication as well as the sub-7 GHz communication and control the timing control loop of these two systems independently.

According to an embodiment of the present disclosure, the dual connectivity transceiver 500 may be a radio base station configured to communicate with user equipment (UE). The UE may a mobile communication device or a fixed wireless device that implements only millimeter wave modules (e.g., millimeter wave modules 508A-508N illustrated in FIG. 5). The number of UE receive paths may be different that the number of base station millimeter wave transmit paths, and similarly, the number of UE transmit paths may be different that the number of base station millimeter wave receive paths. The dual connectivity transceiver 500 may be operated in one of the following exemplary modes of communication.

In a Carrier Aggregation (CA) mode of operation, a particular transmit path of the base station transmits information to the UE on multiple carriers at millimeter wave frequencies. For example, a transmit path of the base station may transmit information to the UE on carriers fc1 and fc2 translated to the millimeter wave bands. The operation may be described as a CA operation on the downlink (DL), which is the base station to the UE communication link. A special case of CA is where a single carrier is used. Similarly, a particular transmit path of the UE may transmit information to the base station on multiple carriers at millimeter wave frequencies, which can be described as a CA operation on the uplink (UL).

Frequency Division Multiplexing (FDM) across paths: In this mode of operation, each base station transmit path, while utilizing CA, also utilizes non-overlapping sets of carriers on the downlink. In one operation example, a base station may transmit to a single UE. In another example, a base station may transmit to multiple UEs, where each UE receives information from a set of carriers transmitted from a particular base station transmit path. As an example, a base station with 2 transmit paths may utilize carriers fc1 and fc2 on path 1, and utilize carriers fc3 and fc4 on path 2. The base station may communicate with UE1 alone, in which case UE1 receives information on all 4 carriers fc1, fc2, fc3, fc4. Alternatively, the base station may communicate with UE1 and UE2, with UE1 receiving information on fc1 and fc2, and UE2 receiving information on fc3 and fc4.

In the Spatial Multiplexing (SM) mode of operation, relying on knowledge of the communication channel between the base station and the UE, multiple information streams are transmitted from the base station to the UE, using the N millimeter wave paths at the base station, all operating on the same set of millimeter wave frequency channels, consisting, for example, of the same set of carriers. As an example, consider a base station which has four millimeter wave transmit paths and the UE has two millimeter wave receive paths. In this case, the maximum rank of the channel matrix between the base station and the UE, corresponding to the maximum number of linearly independent modes of the channel, is 2. The base station baseband processor, making use of this information, may transmit 2 streams of information from all 4 base station transmit paths, by precoding, i.e., weighing each stream differently. The UE receives 2 copies of the transmitted signal, each containing both the streams, at its 2 receive millimeter wave paths. The baseband processor at the UE then separates the 2 streams using the composite receive signals at the two receive paths. This operation may be described as a 4×2 MIMO/Spatial Multiplexing operation on the downlink. A similar operation may be utilized for transmissions for the UE to the base station. In other embodiments, the base station and the UE communicate using various combinations of carrier aggregation, frequency-division-multiplexing and spatial multiplexing.

According to embodiments of the present disclosure, the selection of the IF frequency is based on the consideration of the frequencies generated in the millimeter wave PLL path. In the millimeter wave modules 508A-508N, the IF frequencies are generally referred to as the frequencies prior to up-conversion by the upconverter 536 in the transmit path and following down-conversion by the down-converter 560 in the receive path. In the sub-7 GHz modules 512A-512N, the IF frequencies are referred to as the frequencies after up-conversion by the up-converters 570A-570N in the transmit path and prior to down-conversion by the down-converters 596A-596N in the receive path. The IF frequency of the millimeter wave path should avoid overlap with the sub-7 GHz frequency channel in order to not create an undesired intermodulation product that violates the emission requirements. The IF frequency can be dynamically changed to address the emission requirements for the channel in use.

If the sub-7 GHz channel is not directly generated by the direct RF sampling converters and an IF stage is needed to do the translation, then the second PLL needed for the IF to sub-7 GHz frequency translation must not produce undesired intermodulation or leakage product that violate the emission requirements in the millimeter wave path. Hence, the selection of the two IF frequencies need to be carefully made and dynamically changed based on the channel combination of millimeter wave and sub-7 GHz channels in use.

For example, if the bandwidth for the sub-7 GHz signals is BW1 and the bandwidth for millimeter wave signals is BW2, then the separation between the IF (intermediate-frequency) for millimeter wave band and the IF (which is also the RF (radio frequency) when it is directly generated by the direct RF sampling) for sub-7 GHz is greater than (BW1+BW2). The RF for sub-7 GHz is indicated by reference numeral 574. The IF (intermediate-frequency) for millimeter wave band is different than the RF (radio frequency) for sub-7 GHz and there is no overlap between the IF (intermediate-frequency) for millimeter wave band and the RF (radio frequency) for sub-7 GHz.

Table 4 summarizes different architectural configurations covered by embodiments of the present disclosure.

TABLE 4
Architectural configurations

| Combination | Description |
|---|---|
| 000 | Shared Antenna, No frequency conversion at IF |
| 001 | Shared Antenna, Frequency conversion at IF |
| 110 | RX & TX Antenna, No frequency conversion at IF |
| 111 | RX & TX Antenna, Frequency conversion at IF |

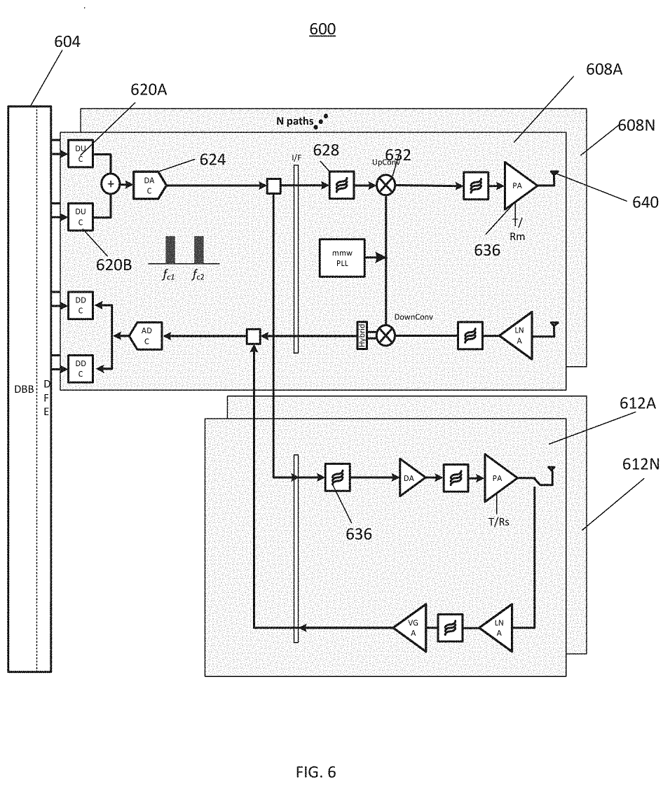

FIG. 6 illustrates a dual connectivity wireless transceiver 600 in accordance with another embodiment of the present disclosure. The transceiver 600 comprises a single baseband module 604 connected to millimeter wave modules 608A-608N and to sub-7 GHz modules 612A-612N. For each of the N paths, a millimeter wave module and a sub-7 GHz module are provided. The transceiver 600 utilizes a single baseband module 604 connected to the millimeter wave modules 608A-608N and the sub-7 GHz modules 612A-612N to provide wireless communication in the millimeter wave band and in the sub-7 GHz band.

In each pair of transmit paths, one of which is the transmit path for the millimeter wave module and the other for the sub-7 GHz module, two carrier frequencies are frequency multiplexed in digital domain by digital up-converters 620A-620B, and converted from digital to analog by a DAC 624. The analog signal is split into two signals, and a first signal is provided to the millimeter wave module 608A and a second signal is provided to the sub-7 GHz module 612A. The signal intended for the millimeter wave module 608A is centered at an IF frequency IFm (this can be either f_{c1} or f_{c2}) while the signal intended for the sub-7 GHz module 612A is centered directly at the intended channel of the sub-7 GHz band. In the millimeter wave module 608A, the signal is passed through a filter 628 which rejects the undesired sub-7 GHz frequency and is up-converted to millimeter wave band by an upconverter 632. The millimeter wave band signal is amplified by a power amplifier 636 and radiated by an antenna 640. Similarly, in the sub-7 GHz module, the signal is passed through a filter 636 which outputs the desired sub-7 GHz signal. If the direct RF sampling converter cannot operate at the desired sub-7 GHz frequency, a second mixing stage similar to the millimeter wave section is needed to convert the IF frequency to the desired sub-7 GHz channel and vice versa.

The advantage of the system in FIG. 6 is that it reduces the number of converters needed to support the MIMO system operating between millimeter wave and sub-7 GHz by taking advantage of their wide bandwidth of operation and passing several carriers through a single converter. The carriers are subsequently extracted in the analog section by using RF filters and in digital section for the receiver using digital filters. In one example, a 4-streamMlMO communication system, with 2 streams each transmitted on the mmw and sub-7 GHz sections, can be implemented by the system shown in FIG. 6 by synthesizing four MIMO streams and placing two on to two mmw paths and the other two on to the sub-7 GHz path using just two DACs. An 8-stream MIMO system, with 4 streams each on the mmw and sub-7 GHz sections, can be implemented by using just 4 DACs and 4 ADCs thereby reducing the required hardware and reducing power consumption. In the 8-stream MIMO system, 4 streams are mapped to f_{c1} while the other 4 streams are mapped to f_{c2}. Assuming the sub-7 GHz band is the 3.4-4.2 GHz band, f_{c1} can arbitrarily be chosen at 2.4 GHz, whereas f_{c2} can be chosen as the desired channel in the 3.4-4.2 GHz band. f_{c1} is the IF for mmw path (IFm) and is frequency converted to the desired mmw band using the mmw path.

The combinations shown in Table 4 also apply to the implementation shown in FIG. 6. A mmw switch can be used to reduce mmw antennas by a factor of two by sharing antennas between the transmit and the receive paths. However, mmw antennas are generally very small and RF switch causes an insertion loss between the PA and the antenna and is expensive from the perspective of achieving high EIRP.

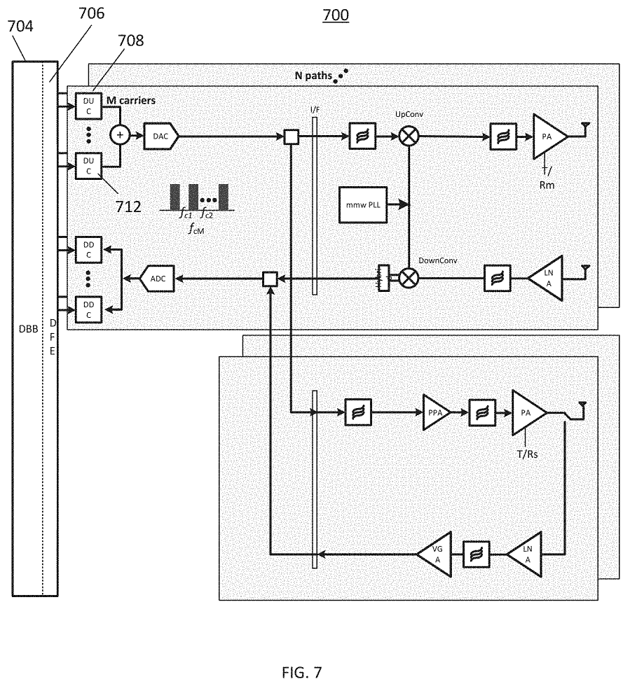

A further generalized system 700 is shown in FIG. 7 which can aggregate M carriers for data conversion. This aggregation can be done in many ways. For example, M/2 carriers can be aggregated by DBB 704 and DUCs 708 and 712 can perform the final aggregation one for the mmw band and the other for the sub-7 GHz band. In another example, only one DUC is used and the entire aggregation can be done prior to it in the DBB. DUCs can be a part of the DFE 706. Multiple frequency bands can be addressed by extending the concept presented to more than two bands. For example, a tri-band carrier aggregation can be performed by adding a third section to FIG. 5-7. The third band can be a sub-7 GHz band or a mmw band.

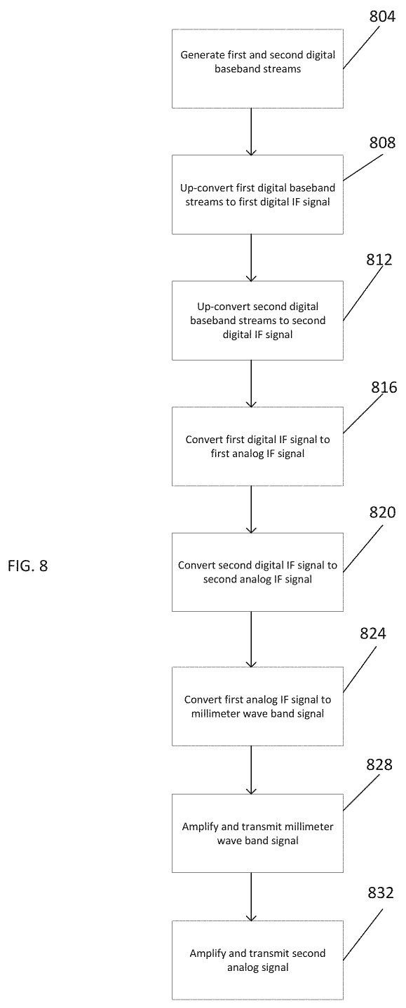

FIG. 8 is a functional block diagram illustrating example blocks executed to implement one aspect of the present disclosure. In a block 804, N first and second digital baseband signal streams are generated. The first digital baseband signal streams are digitally up-converted to a first digital intermediate frequency (IF) signal of frequency f1 in a block 808. The second digital baseband signal streams are up-converted to a second digital intermediate frequency (IF) signal of frequency f2 in a block 812.

In a block 816, the first digital IF signal of frequency f1 is converted to a first analog IF signal of frequency f1, and in a block 820, the second digital IF signal of frequency f1 to a second analog IF signal of frequency f2. The first analog IF signal of frequency f1 is up-converted to a millimeter wave band signal of frequency f3 in a block 824. The millimeter wave band of frequency f3 is amplified and transmitted in a block 828. The second analog signal of frequency f2 is amplified and transmitted in a block 832.

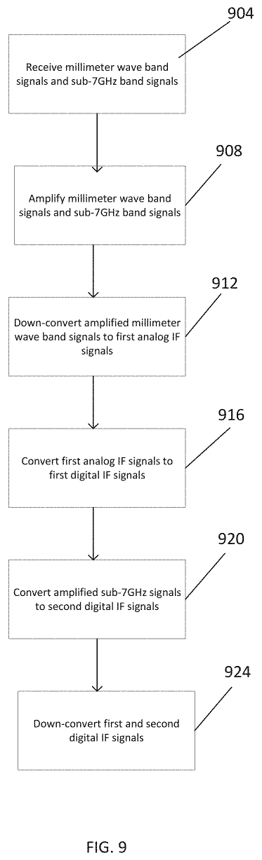

FIG. 9 is a functional block diagram illustrating example blocks executed to implement another aspect of the present disclosure. In a block 904, millimeter wave band signals of frequency f1 and sub-7 GHz signals of frequency f2 are received. The millimeter wave band signals of frequency f1 and the sub-7 GHz signals of frequency f2 are amplified in a block 908. The amplified millimeter wave band signals of frequency f1 are down-converted to first analog intermediate frequency (IF) signals of frequency f3 in a block 912, and the first analog IF signals of frequency f3 are converted to first digital IF signals of frequency f3 in a block 916.

In a block 920, the amplified sub-7 GHz signals are converted to second digital IF signals. The first and second digital IF signals are digitally down-converted to respective first and second digital baseband signals in a block 924.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution.

1. A method for wireless communication, comprising:
generating N first and second digital baseband signal streams;
digitally up-converting the first digital baseband signal streams to a first digital intermediate frequency (IF) signal of frequency f1;
digitally up-converting the second digital baseband signal streams to a second digital intermediate frequency (IF) signal of frequency f2, wherein f1 is not equal to f2;
converting the first digital IF signal of frequency f1 to a first analog IF signal of frequency f1;
converting the second digital IF signal of frequency f1 to a second analog IF signal of frequency f2;
up-converting the first analog IF signal of frequency f1 to a millimeter wave band signal of frequency f3;
amplifying the millimeter wave band of frequency f3 and transmitting the amplified millimeter wave band signal of frequency f3;
amplifying the second analog signal of frequency f2 and transmitting the amplified signal, wherein f3 is greater than f2 by at least 10 GHz.

2. The method of claim 1, further comprising:
connecting a digital baseband module to millimeter wave modules and sub-7 GHz modules;
generating, by the digital baseband module, the N first and second digital baseband signal streams;
routing each of the N first digital baseband signal streams to respective millimeter wave modules; and
routing each of the N second digital baseband signal streams to respective sub-7 GHz modules.

3. The method of claim 1, further comprising filtering the first analog IF signal of frequency f1 prior to up-conversion to the millimeter wave band signal of frequency f3.

4. The method of claim 1, wherein the second analog signal of frequency f2 is filtered and transmitted without up-conversion.

5. The method of claim 1, wherein respective center frequencies of the first and second analog IF signals are spaced to prevent interference between the millimeter wave modules and the sub-7 GHz modules.

6. The method of claim 1, wherein the N first and second digital baseband signal streams are generated by a digital baseband module connected to a plurality of millimeter wave modules and a plurality of sub-7 GHz modules.

7. The method of claim 1, wherein the millimeter wave band signals have a frequency greater than 24 GHz.

8. The method of claim 1, wherein f2 is less than or equal to 7 GHz.

9. A method for wireless communication, comprising:
receiving millimeter wave band signals of frequency f3 and sub-7 GHz signals of frequency f2;
amplifying the millimeter wave band signals of frequency f3 and the sub-7 GHz signals of frequency f2;
down-converting the amplified millimeter wave band signals of frequency f3 to first analog intermediate frequency (IF) signals of frequency f1;
converting the first analog IF signals of frequency f1 to first digital IF signals of frequency f1;
converting the amplified sub-7 GHz signals to second digital IF signals; and
digitally down-converting the first and second digital IF signals to respective first and second digital baseband signals.

10. The method of claim 9, wherein f3 is greater than f2 by at least 10 GHz.

11. The method of claim 9, further comprising receiving the millimeter wave band signals and the sub-7 GHz signals at respective millimeter wave and sub-7 GHz modules.

12. The method of claim 9, further comprising:
connecting the millimeter wave modules and the sub-7 GHz band module to a digital baseband module; and
processing the first and second digital baseband signals by a digital baseband module.

13. The method of claim 9, further comprising filtering the amplified millimeter wave band signals of frequency f3 prior to down-conversion to the first analog IF signals.

14. The method of claim 9, further comprising converting the amplified sub-7 GHz signals to the second digital IF signals without a down-conversion.

15. The method of claim 9, further comprising filtering the amplified sub-7 GHz signals prior to conversion to the second digital IF signals.

16. The method of claim 9, wherein respective center frequencies of the first analog IF signals and the sub-7 GHz signals are spaced to prevent interference between the millimeter wave modules and the sub-7 GHz modules.

17. An apparatus configured for wireless communication, comprising:
means for generating N first and second digital baseband signal streams;
means for digitally up-converting the first digital baseband signal streams to a first digital intermediate frequency (IF) signal of frequency f1;
means for digitally up-converting the second digital baseband signal streams to a second digital intermediate frequency (IF) signal of frequency f2, wherein f1 is not equal to f2;
means for converting the first digital IF signal of frequency f1 to a first analog IF signal of frequency f1;
means for converting the second digital IF signal of frequency f1 to a second analog IF signal of frequency f2;
means for up-converting the first analog IF signal of frequency f1 to a millimeter wave band signal of frequency f3;
means for amplifying the millimeter wave band of frequency f3 and transmitting the amplified millimeter wave band signal of frequency f3;
means for amplifying the second analog signal of frequency f2 and transmitting the amplified signal, wherein f3 is greater than f2 by at least 10 GHz.

18. The apparatus of claim 17, further comprising:
means for routing each of the N first digital baseband signal streams to respective millimeter wave modules; and
means for routing each of the N second digital baseband signal streams to respective sub-7 GHz modules.

19. The apparatus of claim 17, further comprising means for filtering the first analog IF signal of frequency f1 prior to up-conversion to the millimeter wave band signal of frequency f3.

20. The apparatus of claim 17, wherein respective center frequencies of the first and second analog IF signals are spaced to prevent interference between the millimeter wave modules and the sub-7 GHz modules.

21. The apparatus of claim 17, wherein the millimeter wave band signals have a frequency greater than 24 GHz.

22. The apparatus of claim 17, wherein f2 is less than or equal to 7 GHz.

23. The apparatus of claim 17, wherein the apparatus is a radio base station.

24. The apparatus of claim 17, wherein the apparatus is a user equipment (UE).

25. The apparatus of claim 17, wherein the apparatus is a wireless broadband modem.

26. An apparatus configured for wireless communication, comprising:
means for receiving millimeter wave band signals of frequency f3 and sub-7 GHz signals of frequency f2;
means for amplifying the millimeter wave band signals of frequency f3 and the sub-7 GHz signals of frequency f2;
means for down-converting the amplified millimeter wave band signals of frequency f3 to first analog intermediate frequency (IF) signals of frequency f1;
means for converting the first analog IF signals of frequency f1 to first digital IF signals of frequency f1;
means for converting the amplified sub-7 GHz signals to second digital IF signals; and
means for digitally down-converting the first and second digital IF signals to respective first and second digital baseband signals.

27. The apparatus of claim 26, wherein f3 is greater than f2 by at least 10 GHz.

28. The apparatus of claim 26, further comprising means for receiving the millimeter wave band signals and the sub-7 GHz signals at respective millimeter wave and sub-7 GHz modules.

29. The apparatus of claim 26, further comprising means for filtering the amplified millimeter wave band signals of frequency f3 prior to down-conversion to the first analog IF signals.

30. The apparatus of claim 26, further comprising means for converting the amplified sub-7 GHz signals to the second digital IF signals without a down-conversion.

31. The apparatus of claim 26, further comprising means for filtering the amplified sub-7 GHz signals prior to conversion to the second digital IF signals.

32. The apparatus of claim 26, wherein respective center frequencies of the first analog IF signals and the sub-7 GHz signals are spaced to prevent interference between the millimeter wave modules and the sub-7 GHz modules.

33. The apparatus of claim 26, wherein the apparatus is a radio base station.

34. The apparatus of claim 26, wherein the apparatus is a user equipment (UE).

35. The apparatus of claim 26, wherein the apparatus is a wireless broadband modem.

36. A method for wireless communication, comprising:
generating N digital baseband signal streams;
digitally up-converting the digital baseband signal streams to at least two digital intermediate frequency (IF) signals of frequency f1 and frequency f2;
converting the digital IF signals of frequency f1 and frequency f2 to an analog IF signal having frequencies f1 and f2;
filtering the analog IF signal having frequencies f1 and f2 to generate a first analog IF signal of frequency f1;
filtering the analog IF signal having frequencies f1 and f2 to generate a second analog IF signal of frequency f2;
up-converting the first analog IF signal of frequency f1 to a millimeter wave band signal of frequency f3;
amplifying the millimeter wave band of frequency f3 and transmitting the amplified millimeter wave band signal of frequency f3;
amplifying the second analog signal of frequency f2 and transmitting the amplified signal, wherein f3 is greater than f2 by at least 10 GHz.

37. The method of claim 36, further comprising:
connecting a digital baseband module to millimeter wave modules and sub-7 GHz modules;
generating, by the digital baseband module, the digital baseband signal streams;
digitally up-converting, at the millimeter wave modules, the digital baseband signal streams to at least two digital intermediate frequency (IF) signals of frequency f1 and frequency f2;
converting, at the millimeter wave modules, the digital IF signals of frequency f1 and frequency f2 to an analog IF signal having frequencies f1 and f2;
filtering, at the millimeter wave modules, the analog IF signal having frequencies f1 and f2 to generate a first analog IF signal of frequency f1;
filtering, at the sub-7 GHz modules, the analog IF signal having frequencies f1 and f2 to generate a second analog IF signal of frequency f2;
up-converting, at the millimeter wave modules, the first analog IF signal of frequency f1 to a millimeter wave band signal of frequency f3;
amplifying, at the millimeter wave modules, the millimeter wave band of frequency f3 and transmitting the amplified millimeter wave band signal of frequency f3;
amplifying, at the sub-7 GHz modules, the second analog signal of frequency f2 and transmitting the amplified signal, wherein f3 is greater than f2 by at least 10 GHz.

38. The method of claim 36, further comprising filtering the millimeter wave band signals prior to transmission.

39. A method for wireless communication, comprising:
receiving millimeter wave band signals of frequency f3 and sub-7 GHz signals of frequency f2;
amplifying the millimeter wave band signals of frequency f3 and the sub-7 GHz signals of frequency f2;
down-converting the amplified millimeter wave band signals of frequency f3 to first analog intermediate frequency (IF) signals;
summing the first analog IF signals and the amplified sub-7 GHz signals and digitally down-converting the summed signals to digital baseband signals, wherein f3 is greater than f2 by at least 10 GHz.

40. The method of claim 39, further comprising receiving the millimeter wave band signals and the sub-7 GHz signals at respective millimeter wave and sub-7 GHz modules.

41. The method of claim 39, further comprising:
amplifying the millimeter wave band signals of frequency f3 at the millimeter wave modules and amplifying the sub-7 GHz signals of frequency f2 at the sub-7 GHz modules;
down-converting, at the millimeter wave modules, the amplified millimeter wave band signals of frequency f3 to first analog intermediate frequency (IF) signals;
routing the amplified sub-7 GHz signals to the millimeter wave modules;
summing, at the millimeter wave modules, the first analog IF signals and the routed amplified sub-7 GHz signals; and
digitally down-converting, at the millimeter wave modules, the summed signals to digital baseband signals.

42. The method of claim 39, further comprising filtering the amplified millimeter wave signals prior to down-conversion.

43. The method of claim 39, further comprising filtering the amplified sub-7 GHz signals prior to routing to the millimeter wave modules.

44. A method for wireless communication, comprising:
generating digital baseband signal streams;
digitally up-converting the digital baseband signal streams to a first digital intermediate frequency (IF) signal of frequency f1;
digitally up-converting the digital baseband signal streams to a second digital intermediate frequency (IF) signal of frequency f2, wherein f1 is not equal to f2;
converting the first digital IF signal of frequency f1 to a first analog transmit IF signal of frequency f1;
converting the second digital IF signal of frequency f1 to a second analog transmit IF signal of frequency f2;
up-converting the first analog transmit IF signal of frequency f1 to a millimeter wave band transmit signal of frequency f3 and transmitting the millimeter wave band transmit signal of frequency f3;
transmitting the second analog transmit IF signal of frequency f2, wherein f3 is greater than f2 by at least 10 GHz;
receiving millimeter wave band receive signals of frequency f3 and sub-7 GHz receive signals of frequency f2;
down-converting the millimeter wave band receive signals of frequency f3 to first analog receive intermediate frequency (IF) signals of frequency f1;
summing the first analog receive IF signals and the received sub-7 GHz signals and digitally down-converting the summed signals to digital baseband receive signal streams.

45. The method of claim 44, further comprising:
connecting a digital baseband module to millimeter wave modules and sub-7 GHz modules;
generating, by the digital baseband module, the digital baseband signal streams;
routing a first set of digital baseband signal streams to the millimeter wave modules; and
routing a second set the digital baseband signal streams to the sub-7 GHz modules.
